(19) United States
(12) Patent Application Publication
(10) Pub. No.: US 2012/0071215 A1
(43) Pub. Date: Mar. 22, 2012

(54) Method and Apparatus for Controlling a Smart Phone Charger

(75) Inventors: Francis P. Bourque, Mundelein, IL (US); Sanjay Gupta, Lakewood, IL (US); Irfan Nasir, Lake in the Hills, IL (US)

(73) Assignee: MOTOROLA MOBILITY, INC., Libertyville, IL (US)

(21) Appl. No.: 12/883,237

(22) Filed: Sep. 16, 2010

(51) Int. Cl. H04B 1/38

(52) U.S. Cl. 455/573

(57) ABSTRACT

A method for controlling a charger to charge a power source of an electronic device includes connecting the charger and the electronic device and determining whether the power source of the electronic device is to be charged. The method further includes, the electronic device, sending a first control signal to the charger to enable charging of the power source of the electronic device in response to determining that the power source is to be charged and sending a second control signal to the charger to disable charging of the power source of the electronic device in response to determining that the power source is not to be charged.

### FIELD OF THE DISCLOSURE

The present disclosure generally relates to smart phone chargers and more particularly to a method and apparatus for controlling smart phone chargers.

### BACKGROUND

Electronic devices such as mobile phones, personal digital assistants (PDAs), laptops, etc., include an internal power source such as a battery to provide power for various operations of the electronic device. However, the battery of the electronic device requires charging from an external source such as an alternating current (AC) source.

In general, the electronic device is connected to the AC source through a charger. The charger converts the power from the AC source to a power form suitable for charging the battery of the electronic device. However, it is highly energy inefficient to have the electronic device connected to the charger all the time. Situation such as charging the electronic device throughout the night or keeping the charger active when no device is connected results in a great amount of power loss due to the voltage conversion and regulation processes on both the electronic device and the charger. Therefore, power can be better managed by controlling the charging of the battery of the electronic device.

Accordingly, there is a need for method and apparatus for controlling a smart phone charger.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a charging system in accordance with some embodiments.

FIG. 2 illustrates a schematic of a charging system in accordance with some embodiments.

FIG. 3 illustrates a flow diagram describing a method for controlling a smart phone charger in accordance with some embodiments.

FIG. 4 illustrates a flow diagram describing a method for charging in the charging system of FIG. 1 in accordance with some embodiments.

FIG. 5 is a block diagram illustrating an embodiment of an electronic device employed in the charging system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method and apparatus for controlling a charger to charge a power source of an electronic device is described herein. The method includes connecting the charger and the electronic device and determining, by the electronic device, whether the power source of the electronic device, for example, a battery embedded in the electronic device, is to be charged. The method further includes, the electronic device, sending a first control signal to the charger to enable charging of the power source of the electronic device in response to determining that the power source is to be charged and sending a second control signal to the charger to disable charging of the power source of the electronic device in response to determining that the power source is not to be charged.

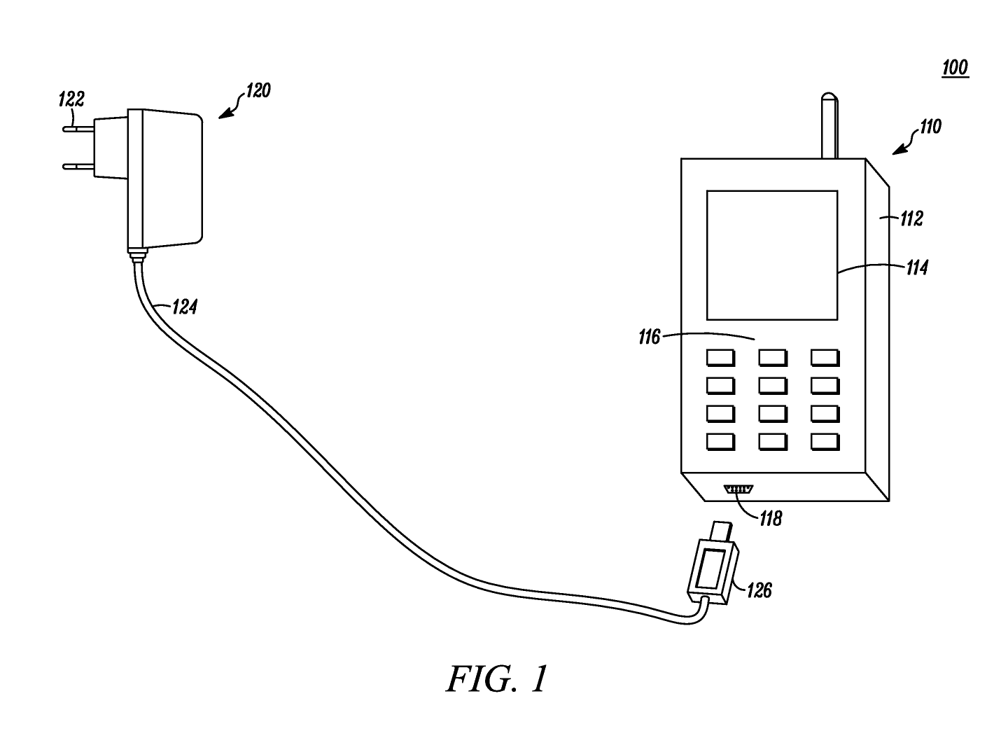

Referring to the figures, FIG. 1 is a block diagram of a charging system 100 in accordance with some embodiments. The charging system 100 includes an electronic device, such as a mobile phone 110 connected to a charger, such as a smart phone charger 120. The charging system 100 is not limited to a mobile phone 110 connected to a smart phone charger 120 but may also include, other electronic devices such as mobile radios, mobile stations, subscriber units, access terminals, mobile devices, digital cameras, portable computing devices, laptops, two-way radios, cellular phones, Personal Digital Assistants (PDAs), pagers, remote control devices, broadband equipments such as, set top boxes and digital video recorders, or any other device having an in built power source capable of being charged by a charger device.

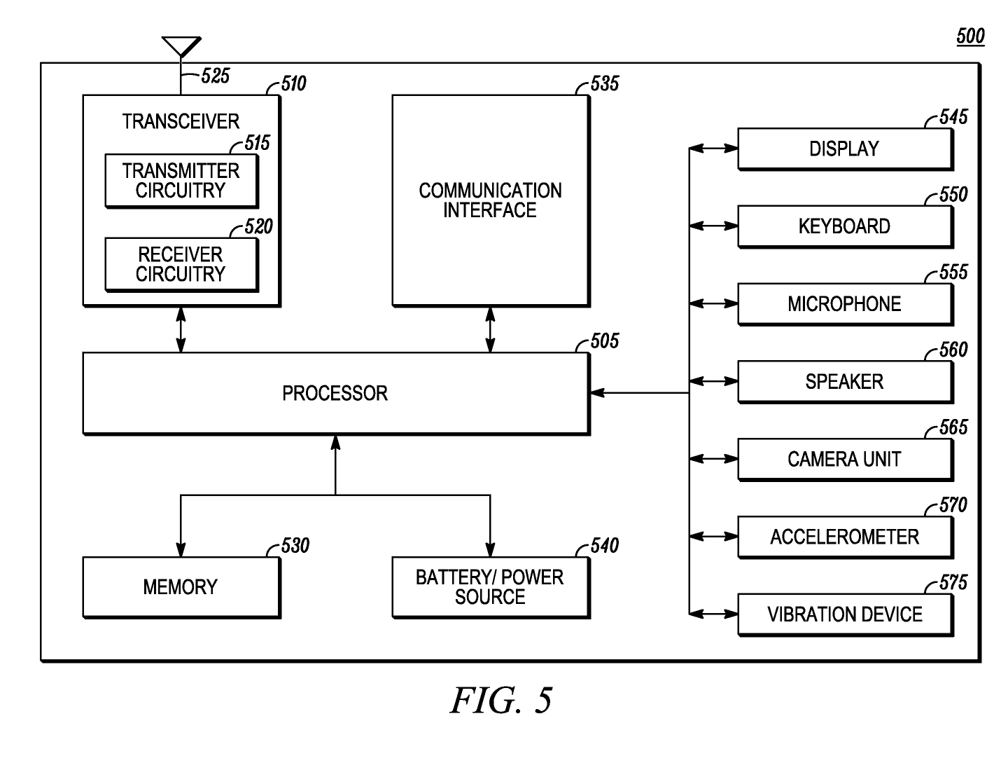

Referring to FIG. 1, the mobile phone 110 includes a casing 112 enclosing different units of the mobile phone 110, such as, a display area 114, a keypad 116, and a socket 118 for receiving a connector 126 from the smart phone charger 120. The casing 112 may also support and/or enclose other units such as a microphone, a speaker, a camera, a processor, a memory, a power source, for example, a battery to supply power for the various operations of the mobile phone 110, an accelerometer, a vibration device, etc., of the mobile phone 110. The casing 112 may also include other units that are not mentioned here, however, that are required for performing various operations of the mobile phone 110. The details of the various units of the mobile phone 110 are explained with reference to FIG. 5.

Returning to FIG. 1, the smart phone charger 120 includes a plug 122 for connecting to an external power supply such as, AC mains and a cable 124 with a connector 126 for connecting to the mobile phone 110. The smart phone charger 120 charges power source, for example, a battery present in the mobile phone 110 through the cable 124 and the connector 126. The connector 126 may include, but not limited to, charging pads, barrel connectors, universal serial bus (USB) connectors, such as standard A, standard B, mini A, mini B, micro A, or micro B connectors, proprietary power connectors, and other types of connectors commonly known or used to connect a charger, such as the smart phone charger 120 to the mobile phone 110. The connector 126 includes a plurality of pins having contact with the socket 118 in the mobile phone 110. In one example, when the connector 126 is a USB connector, the plurality of pins include an identification (ID) connection pin, a data positive (D+) connection pin, a data negative (D−) connection pin and a voltage bus (V_{bus}) connection pin.

The various types of connectors, such as USB connectors, are already known in the art. In order to maintain the simplicity of the specification, their detailed description is not provided herewith.

The charging system 100 illustrates a smart phone charger 120 connected to a mobile phone 110 through a USB connector 126 for ease of illustration. However, the teachings of the present invention may be applied to other types of charging systems including a different type of charger connected to any mobile phone through any other type of connector.

Referring to FIG. 1, in accordance with some embodiments, when the mobile phone 110 determines that the power source, for example, the battery of the mobile phone 110 needs charging it sends a first control signal to the smart phone charger 120 via the ID connection pin to enable charging of the power source. On the other hand, when the mobile phone 110 determines that the power source does not need charging it sends a second control signal to the smart phone charger 120 via the ID connection pin to disable charging of the power source.

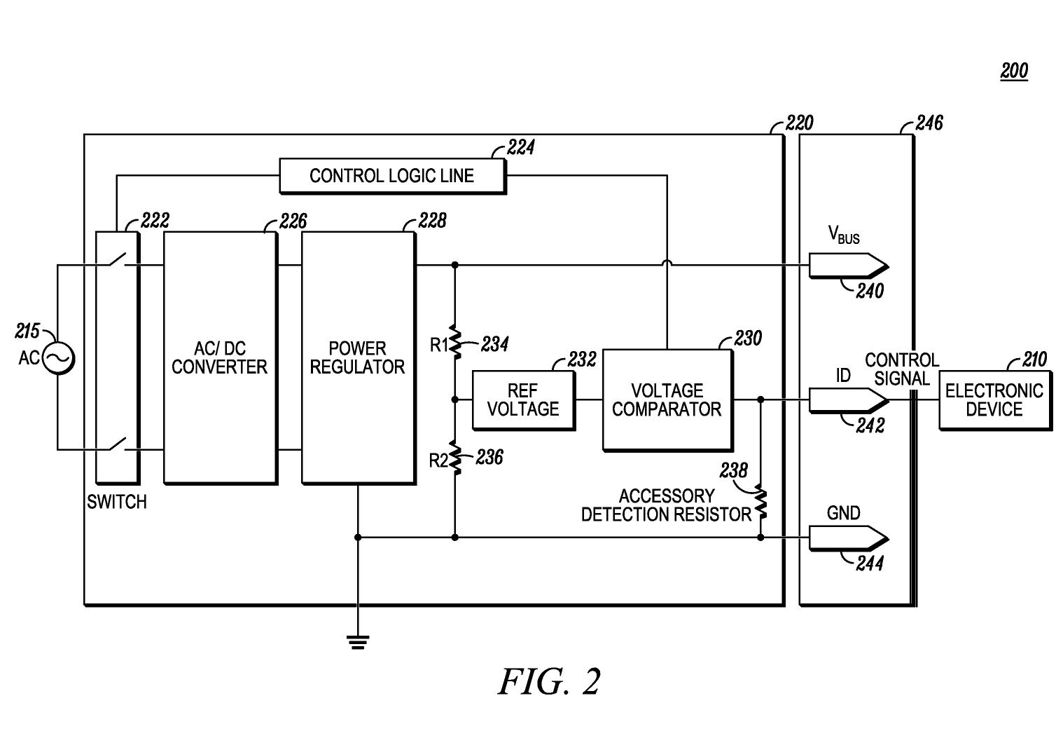

FIG. 2 illustrates a schematic 200 of a charging system 100, as shown in FIG. 1, in accordance with some embodiments. The schematic 200 illustrates an electronic device 210 and the various components of the charger device 220 in accordance with some embodiments of the present invention. The charger device 220 is shown connected to a power generator 215 providing an alternating current (AC) signal on one side and to the electronic device 210 on the other side. The charger device 220 is connected to the electronic device 210 through a connection port 246 having a plurality of connection lines, for example, a power line or V_{BUS} pin 240, an identification line or ID pin 242, and a ground line or GND pin 244. The power generator 215 is coupled to the power line 240 of the connection port 246. The connection port 246 refers to the connector 126 shown in FIG. 1. Referring back to FIG. 2, the main function of the charger device 220 is to convert the AC current from the power generator 215 to a direct current (DC) signal, thereby charging a power source, for example, a battery (not shown) of the electronic device 210. The power generator 215 may provide, for example, a 110V/60 HZ AC supply or a 230V/50 HZ AC supply.

Returning to FIG. 2, the charger device 220 includes a switch 222 coupled to the power generator 215. The switch 222 is capable of operating in a first state or a closed position and a second state or an open position in order to enable or disable power provided to the connection port 246. The charger device 220 further includes an AC/DC converter 226 for converting the AC from the power generator 215 to a DC signal, and a power regulator 228 for regulating the DC signal output from the AC/DC convertor 226. The charger device 220 further includes resistors R1 234 and R2 236 connected to the output of the power regulator 228. The resistors R1 234 and R2 236 are also connected to the V_{BUS} pin 240. The resistors R1 234 and R2 236 provide a reference voltage 232 based on a voltage drop across R2 236. In one example, when the switch is in the closed position, the reference voltage 232 may be the voltage drop across R2 236 based on the voltage output from the power regulator 228. In another example, when the switch is in the open position the reference voltage 232 may be the voltage drop across R2 236 based on a voltage provided by the electronic device 210 on the V_{BUS} pin 240.

Referring to the schematic 200, the charger device 220 includes a voltage comparator 230 for comparing the reference voltage 232 with a voltage level on the ID pin 242 and generating an output based on the comparison, wherein the generated output controls the state (open or closed positions) of the switch 222 through a control logic line 244. Referring to the voltage comparator 230, the voltage level on the ID pin 242 is based on a control signal sent by the electronic device 210. In particular, the electronic device 210 controls the state of the switch 222 by sending a control signal via ID pin 242, thereby, controlling the charging of the power source of the electronic device 210. In accordance with some embodiments, the electronic device 210 determines whether the power source of the electronic device 210 requires charging. If the power source requires charging, the electronic device 210 sends a first control signal providing a first voltage level on the ID pin 242 and if the power source does not require charging, the electronic device 210 sends a second control signal providing a second voltage level on the ID pin 242. In one example, when the voltage level of the control signal provided by the electronic device 210 at the ID pin 242 is a less than the reference voltage level 232, the voltage comparator 230 closes the switch 222 to enable power provided to the connection port 246. In another example, when the voltage level of the control signal provided by the electronic device 210 at the ID pin 242 is greater than the reference voltage level 232, the voltage comparator 230 opens the switch 222 to disable power provided to the connection port 246.

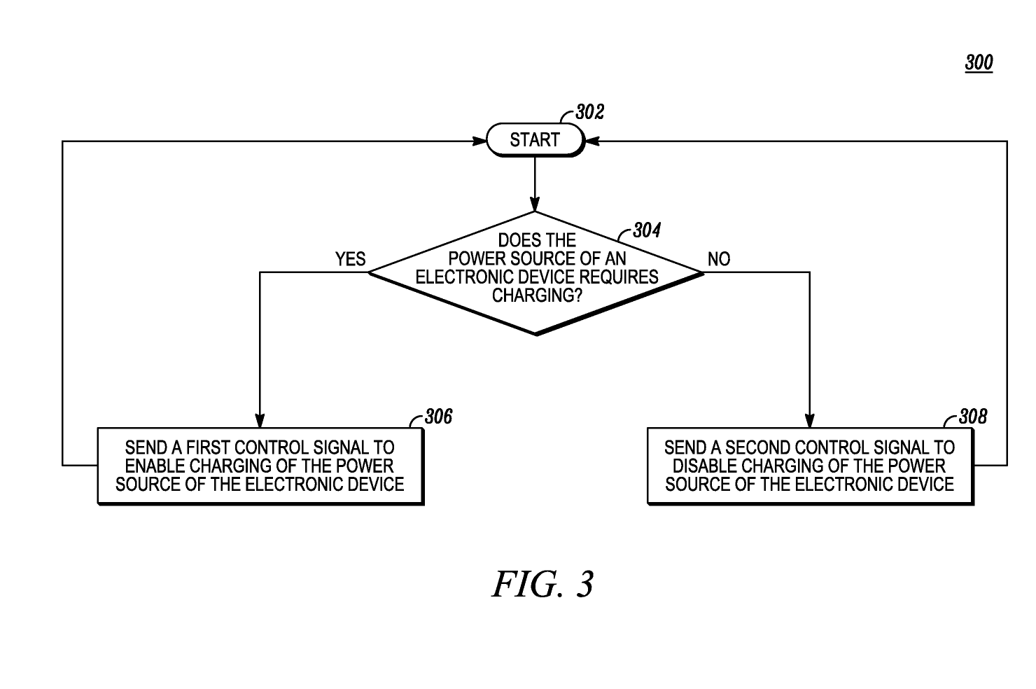

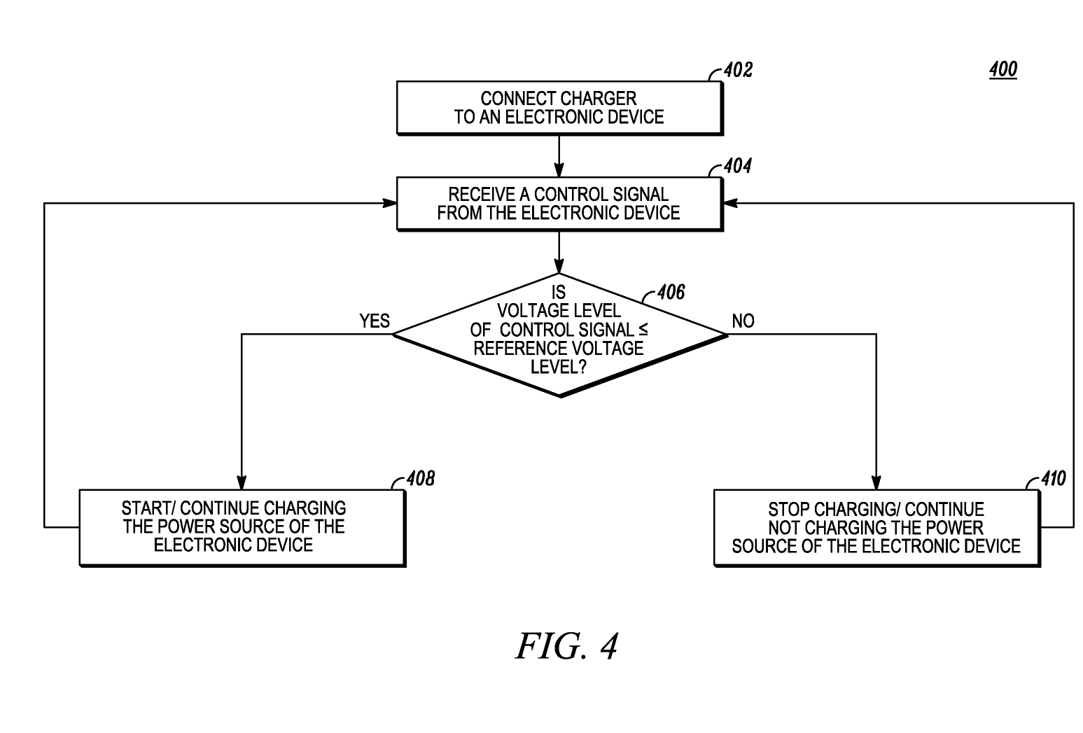

The charger device 220 further includes an accessory detection resistor 238. The accessory detection resistor 238 enables the electronic device 210 to determine a type of charger device 220, for example, mid-rate charger, fast-rate charger, vehicle power adapter, or the like, connected to the electronic device 210. The operation of the electronic device 210 and the charger device 220 are explained with reference to FIGS. 3 and 4 below.

FIG. 3 illustrates a flow diagram describing a method 300 performed by an electronic device 210 for controlling a charger device 220 in accordance with some embodiments. In one embodiment, the method 300 is performed by the mobile phone 110 to control the operations of a smart phone charger 120. The method 300 starts 302 with connecting the electronic device 210 to the charger device 220, wherein the charger device 220 is further connected to a power generator 215 as shown in FIG. 2. Also, it is assumed that, the electronic device 210 requires a minimum amount of power or energy to perform the method 300. In one embodiment, if the power source, for example, the battery of the electronic device 210 is completely dead i.e., the electronic device 210 is totally switched off, the charger device 220 initially supplies a power to the electronic device 210 in order to enable the electronic device 210 to perform the method 300. After receiving a small amount of power from the charger device 220, the electronic device 210 proceeds with performing the method 300.

Referring back to FIG. 3, in the method 300, the electronic device 210 determines 304 whether a power source, for example, the battery of the electronic device 210 requires charging. The determination 304 may be based on at least one of a power source charge level i.e., a power level of the battery, a power source charge cycle i.e., the time duration to charge the battery to its fullest capacity, a power source discharge cycle i.e., the time duration to exhaust the battery power to a minimum value, associated with the electronic device 210. Further, the determination 304 may also be based on an usage pattern, for example, wake-up time, travelling time, a number of voice calls, frequency of short messaging (SMS), etc, a power availability pattern, for example, the power required when a user of the electronic device 210 is at home, work, gym, car, etc, or a power consumption prediction of at least one customized application i.e., charging the battery based on power consumed by applications such as calendar or scheduler, audio or video conference calls, etc, associated with the electronic device 210.

Returning to the method 300, upon determining 304 that the power source requires charging, the electronic device 210 sends 306 a first control signal to the charger device 220 to enable charging of the power source. The first control signal provides a first voltage level on the ID pin 242 and causes the voltage comparator 230 to close the switch 222. The closed position of the switch 222 provides a power path from the power generator 215 to the power line V_{BUS} 240 of the connection port 246 to start the charging of the power source of the electronic device.

On the other hand, upon determining 304 that the power source does not require charging, the electronic device 210 sends 308 a second control signal to the charger device 220 to disable charging of the power source. The second control signal provides a second voltage level on the ID pin 242 and causes the voltage comparator 230 to open the switch 222. The open position of the switch 222 removes the power path from the power generator 215 to the power line V_{BUS} 240 of the connection port 246 to stop the charging of the power source of the electronic device 210. The electronic device 210 continues to perform the method 300 until the charger device 220 is disconnected from the power generator 215 or the electronic device is disconnected from the charger device 220.

In one embodiment, the electronic device 210 may be triggered remotely by another electronic device in order to send a control signal to the charger device 220. In one example, the electronic device 210 may be a home cordless telephone connected to a charger and may be controlled by a mobile phone remotely. The mobile phone may call or send a message to the home cordless telephone, which in turn sends a control signal to the charger to enable or disable the charging by the charger. Thus, the control of charging of the power source of the electronic device 210 may also be performed remotely.

FIG. 4 illustrates a flow diagram describing a method 400 performed by a charger device 220 for charging a power source of an electronic device 210 in accordance with some embodiments. In one embodiment, the method 400 is performed by the smart phone charger 120 for charging a power source of the mobile phone 110. The method 400 begins with the step of connecting 402 the charger device 220 to the electronic device 210. The charger device 220 may be manually connected to the electronic device 210 by a user of the electronic device 210. Upon connecting 402, the charger device 220 may detect the presence of the electronic device 210. After the connection 402, the charger device 220 receives 404 a control signal from the electronic device 210. In accordance with one embodiment, the charger device 220 may detect the connection with the electronic device 210 upon receiving the control signal. The control signal is provided by the electronic device 210 on the ID pin 242 (as shown in FIG. 2) of the connection port 246 (as shown in FIG. 2). Upon receiving 404 the control signal, the charger device 220 determines 406 whether the voltage level of the control signal is less than or equal to a reference voltage level. If the voltage level of the control signal is less than or equal to the reference voltage level , the charger device 220 operates a switch 222 (as shown in FIG. 2) of the charger device 220 in a first state in order to start 408 charging the power source of the electronic device 210. In one embodiment, if the switch 222 is already in the first state i.e. the power source of the electronic device is already being charged and the voltage level of the control signal is less than or equal to a reference voltage level, then the charger device 220 continues 408 to charge the power source of the electronic device 210.

On the other hand, if the voltage level of the control signal is not less than or equal to the reference voltage level or in other words if the voltage level of the control signal is greater than the reference voltage level, the charger device 220 operates the switch 222 (as shown in FIG. 2) of the charger device 220 in a second state in order to stop 410 charging the power source of the electronic device 210. In another embodiment, if the switch 222 is already in the second state i.e. the power source of the electronic device is already not being charged and the voltage level of the control signal is greater than the reference voltage level then the charger device 220 continues 410 with not charging the power source of the electronic device 210.

The charger device 220 continues with steps 404 through 410 of the method 400 until the charger device 220 is disconnected from the power generator 215 or until the charger device 220 is disconnected from the electronic device 210.

FIG. 5 is a block diagram of an electronic device 500 illustrating the internal components according to one embodiment. The electronic device 500 can be the mobile phone 110 in the charging system 100. The electronic device 500 includes a processor 505, a transceiver 510 including a transmitter circuitry 515 and a receiver circuitry 520, an antenna 525, a memory 530 for storing operating instructions that are executed by the processor 505, a communication interface 535, and a battery or power source 540 supplying power for the operation of the electronic device 500. The electronic device 500 further includes user interface modules such as a display 545, a keyboard or keypad 550, a microphone 555, a speaker 560, a camera unit 565, an accelerometer 570, and a vibration device 575. Although not shown, the communication device 500 also can include an antenna switch, duplexer, circulator, or other highly isolative means (not shown) for intermittently providing radio signals from the transmitter circuitry 515 to the antenna 525 and from the antenna 525 to the receiver circuitry 520. The communication device 500 is an integrated unit containing at least all the elements depicted in FIG. 5, as well as any other elements necessary for the communication device 500 to perform its particular electronic function. Alternatively, communication device 500 can comprise a collection of appropriately interconnected units or devices, wherein such units or devices perform functions that are equivalent to the functions performed by the elements of the communication device 500.

The processor 505 includes one or more microprocessors, microcontrollers, DSPs (digital signal processors), state machines, logic circuitry, or any other device or devices that process information based on operational or programming instructions. Such operational or programming instructions are stored in the memory 530. The memory 530 can be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card, external subscriber identity module (SIM) card or any other medium for storing digital information. One of ordinary skill in the art will recognize that when the processor 505 has one or more of its functions performed by a state machine or logic circuitry, the memory 530 containing the corresponding operational instructions can be embedded within the state machine or logic circuitry. The operations performed by the processor 505 and the other elements of the electronic device 500 are described above with reference to FIG. 3.

The transmitter circuitry 515 and the receiver circuitry 520 enable the electronic device 500 to communicate radio signals to and acquire signals from an infrastructure device such as, a base station. In this regard, the transmitter circuitry 515 and the receiver circuitry 520 include appropriate, conventional circuitry to enable digital or analog transmissions over a wireless communication channel. The implementations of the transmitter circuitry 515 and the receiver circuitry 520 depend on the implementation of the electronic device 500. For example, the transmitter circuitry 515 and the receiver circuitry 520 can be implemented as an appropriate wireless modem, or as conventional transmitting and receiving components of two-way wireless communication devices. In the event that the transmitter circuitry 515 and the receiver circuitry 520 are implemented as a wireless modem, the modem can be internal to the electronic device 500 or insertable into the electronic device 500 (e.g., embodied in a wireless radio frequency (RF) modem implemented on a Personal Computer Memory Card International Association (PCMCIA) card or a universal serial bus (USB) card). For a wireless communication device, the transmitter circuitry 515 and the receiver circuitry 520 are implemented as part of the wireless device hardware and software architecture in accordance with known techniques. One of ordinary skill in the art will recognize that most, if not all, of the functions of the transmitter circuitry 515 and/or the receiver circuitry 520 can be implemented in a processor, such as the processor 505. However, the processor 505, the transmitter circuitry 515, and the receiver circuitry 520 have been artificially partitioned herein to facilitate a better understanding.

The receiver circuitry 520 is capable of receiving radio frequency (RF) signals from at least one frequency band and optionally multiple frequency bands, when, for example, the communications with a proximate device are in a frequency band other than that of the system communications. The transceiver 510 includes one set of transmitter circuitry 515. The antenna 525 comprises any known or developed structure for radiating and receiving electromagnetic energy in the frequency range containing the wireless carrier frequencies. The communication interface 535 uses transceiver 510 to enable the electronic device 500 to communicate with other devices and/or systems.

As illustrated in FIG. 5, the power source, for example, the battery 540 supplies power for performing various operations of the electronic device. The battery may include rechargeable batteries such as, Lithium Ion batteries, Lithium Polymer batteries, Nickel Cadmium batteries, Nickel Meta Hydride batteries, and the like. The battery 540 can be charged by an AC current source by manually connecting the mobile device 110 to the AC current source through a charger 120. The battery 540 is connected to the processor 505 so that the processor can monitor a power level of the battery and accordingly generate some control signals. The control signals are sent by the electronic device 500 to the charger 120 to enable or disable charging of the battery 540.

The electronic device 500 includes input devices such as the keypad 550 for entering the phone number of the called party, typing text messages, emails, instant messages, entering address information, and the like, the microphone 555 to input voice data from a user of the electronic device, an accelerometer 570 for user interface control, for example, presenting landscape or portrait views of the electronic device's screen to the user, based on the way the electronic device 500 is being held.

The electronic device 500 also includes output devices such as, the display 545 for displaying the output resulting from various operations of the electronic device 500. The display 545 may include, such as but not limited to, a graphical display, a touch-sensitive display capable of detecting/sensing an input from the user when the user touches some of the displayed data, and the like. The electronic device 500 further includes the speaker 560 to output audio signals such as, voice signals or music, to the user and the vibration device 575 for generating vibrations to indicate the user regarding a call or a message received. The electronic device 500 also includes imaging devices such as, the camera unit 565 for capturing images.

Advantages of the various embodiments include: efficiently managing power resources by controlling an operation of a smart phone charger connected to a mobile phone, wherein the operation of the smart phone charger is controlled by the mobile phone based on a battery status, usage patterns, etc., associated with the mobile phone. The present method avoids wastage of power in situations such as overnight charging of a mobile phone, keeping the smart phone charger active when no mobile phone is connected to it, etc.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of an electronic device for controlling a charger, the electronic device including a power source, the method comprising:
connecting the charger and the electronic device;
determining whether the power source of the electronic device is to be charged;
sending a first control signal to the charger to enable charging of the power source of the electronic device in response to determining that the power source is to be charged; and
sending a second control signal to the charger to disable charging of the power source of the electronic device in response to determining that the power source is not to be charged.

2. The method of claim 1, wherein determining includes:
determining at least one of:
a power source charge level,
a power source charge cycle,
a power source discharge cycle,
an usage pattern,
a power availability pattern, or
a power consumption prediction of at least one customized application, associated with the electronic device.

3. The method of claim 1, wherein connecting the charger and the electronic device includes using an universal serial bus (USB) connector to connect the charger and the electronic device, wherein the USB connector includes a plurality of connection pins.

4. The method of claim 3, wherein the plurality of connection pins include at least one of:
an identification (ID) connection pin, a data positive (D+) connection pin, a data negative (D−) connection pin, or a voltage bus (V_{bus}) connection pin.

5. The method of claim 4, wherein sending the first control signal includes providing a first voltage level on the ID connection pin to start the charging of the power source of the electronic device.

6. The method of claim 4, wherein sending the second control signal includes providing a second voltage level on the ID connection pin to stop the charging of the power source of the electronic device.

7. A method of a charger for charging a power source of an electronic device, the method comprising:
connecting the charger and the electronic device;
receiving a control signal from the electronic device; and
enabling or disabling power to the power source of the electronic device based on the received control signal.

8. The method of claim 7, wherein enabling power to the power source of the electronic device includes:
operating a switch of the charger in a first state to start charging the power source of the electronic device in response to determining that the received control signal includes a first voltage level.

9. The method of claim 7, wherein disabling power to the power source of the electronic device includes:
operating a switch of the charger in a second state to stop charging the power source of the electronic device in response to determining that the received control signal includes a second voltage level.

10. The method of claim 7, wherein connecting the charger and the electronic device includes using an universal serial bus (USB) connector to connect the charger to the electronic device, wherein the USB connector includes a plurality of connection pins.

11. The method of claim 10, wherein the plurality of connection pins include at least one of:
an identification (ID) connection pin, a data positive (D+) connection pin, a data negative (D−) connection pin, or a voltage bus (V_{bus}) connection pin.

12. The method of claim 11, further comprising:
receiving the control signal from the electronic device via the ID connection pin of the USB connector.

13. A charger for charging a power source of an electronic device, the charger comprising:
a connection port including at least one power line and an identification line;
a power generator coupled to the at least one power line of the connection port;
a switch coupled to the power generator, the switch enabling or disabling power provided to the connection port; and
a voltage comparator connected to the identification line, the voltage comparator determining whether to cause the switch to enable or disable power provided to the connection port based on a control signal provided by the electronic device at the identification line.

14. The charger of claim 13, wherein the control signal is based on at least one of:
a power source charge level,
a power source charge cycle,
a power source discharge cycle,
an usage pattern,
a power availability pattern, or
a power consumption prediction of at least one customized application, associated with the electronic device.

15. The charger of claim 13, wherein the connection port comprises:
an universal serial bus (USB) connector including a plurality of connection pins.

16. The charger of claim 15, wherein the plurality of connection pins include at least one of:
an identification (ID) connection pin, a data positive (D+) connection pin, a data negative (D−) connection pin, or a voltage bus (V_{bus}) connection pin.

17. The charger of claim 13, wherein the voltage comparator:
compares a voltage level of the control signal provided by the electronic device at the identification line with a reference voltage level; and
controls the switch through a control logic line, to enable or disable power provided to the connection port, based on the comparison.

18. The charger of claim 17, wherein the voltage comparator:
closes the switch to enable power provided to the connection port, when the voltage level of the control signal provided by the electronic device at the identification line is a less than the reference voltage level; and
opens the switch to disable power provided to the connection port, when the voltage level of the control signal provided by the electronic device at the identification line is greater than the reference voltage level.

19. The charger of claim 13, further comprising:
an accessory detection resistor for enabling the electronic device to detect a type of charger connected to the electronic device.

20. The charger of claim 13, wherein the electronic device includes at least one of a two-way radio, a mobile phone, a cellular phone, a Personal Digital Assistant (PDA), a laptop, or a pager.
